(19) United States
(12) Patent Application Publication
(10) Pub. No.: US 2023/0377232 A1
(43) Pub. Date: Nov. 23, 2023

(54) IMAGE GENERATING METHOD, IMAGE GENERATING DEVICE, AND STORAGE MEDIUM

(71) Applicant: Kabushiki Kaisha Yaskawa Denki, Kitakyushu-shi (JP)

(72) Inventors: Keita SATSUMA, Kitakyushu-shi (JP); Keisuke NAKAMURA, Kitakyushu-shi (JP); Tsuyoshi YOKOYA, Kitakyushu-shi (JP)

(73) Assignee: Kabushiki Kaisha Yaskawa Denki, Kitakyushu-shi (JP)

(21) Appl. No.: 18/363,088

(22) Filed: Aug. 1, 2023

Related U.S. Application Data
(63) Continuation of application No. PCT/JP2022/005630, filed on Feb. 14, 2022.
(60) Provisional application No. 63/272,173, filed on Oct. 27, 2021.

(30) Foreign Application Priority Data
Feb. 15, 2021 (JP) 2021-022117

(51) Int. Cl. G06T 11/60; G06T 7/10; G06T 7/00

(52) U.S. Cl. CPC G06T 11/60; G06T 7/10; G06T 7/0004; G06T 2207/20081; G06T 2207/20084; G06T 2207/30128; G06T 2207/20212

(57) ABSTRACT

Provided is a training image generating method that facilitates preparation of training images for constructing an image recognition model and reduces a period of time required for collecting data on images of defective products to be used as the training images. The training image generating method includes creating a SinGAN model including a generator and a discriminator in each of a plurality of layers based on a first image having a portion of interest shown partially on a target object, generating an input image by compositing a target object image and a portion-of-interest image, and generating, based on the SinGAN model and the input image, a second image exhibiting a portion of interest different in mode from that of the first image.

### CROSS-REFERENCE TO RELATED APPLICATION

The present disclosure contains subject matter related to that disclosed in International Patent Application PCT/JP2022/005630 filed in the Japan Patent Office on Feb. 14, 2022, which claims priority to Japanese Patent Application JP2021-022117 filed on Feb. 15, 2021 and U.S. Provisional Application No. 63/272,173 filed on Oct. 27, 2021. The entire contents of which are hereby incorporated by reference.

### BACKGROUND OF THE INVENTION

### 1. Field of the Invention

The present invention relates to an image generating method, an image generating device, and a storage medium.

### 2. Description of the Related Art

In accordance with recent development of deep learning technology, image recognition technology using machine learning models has come to be used for visual inspection of products manufactured at factories and the like.

### SUMMARY OF THE INVENTION

The machine learning models described above may be applied to, for example, detection of defective products, but it is required to prepare a large number of images of defective products in order to improve accuracy of recognizing whether or not the products are defective. However, in actual production sites, an occurrence frequency of defective products is low in many cases, and it has been difficult to secure images of a sufficient number of defective products.

In addition, products such as food products are in mutually different states (shapes, types of ingredients, positions thereof, and the like) during manufacturing, and hence images of products in various states may be required in order to determine finished quality (for example, quality of food presentation).

However, preparing a sufficient number of defective products and manufacturing a large number of products in various states have been laborious and have required a long period of time.

A problem to be solved by the present invention is to facilitate preparation of images of products in various states and training images for constructing an image recognition model and to reduce a period of time required for collection of such images.

According to one aspect of the present disclosure, there is provided an image generating method including: creating a SinGAN model including a generator and a discriminator in each of a plurality of layers based on a first image having a portion of interest shown partially on a target object; generating an input image by compositing a target object image and a portion-of-interest image; and generating, based on the SinGAN model and the input image, a second image exhibiting a portion of interest different in mode from the portion of interest of the first image.

Further, in the image generating method according to another aspect of the present disclosure, the generating of the second image includes inputting the input image to the generator in an intermediate layer among the plurality of layers.

Further, in the image generating method according to another aspect of the present disclosure, the generating of the input image includes generating the input image by cutting out a region of the portion of interest and a periphery of the portion of interest from the composited target object image and portion-of-interest image.

Further, in the image generating method according to another aspect of the present disclosure, the generator in the intermediate layer is determined based on a layout of the portion of interest shown in the input image.

Further, in the image generating method according to another aspect of the present disclosure, the generating of the input image includes acquiring region information on the portion of interest, and the generating of the second image includes: inputting the input image to the SinGAN model to generate an output image exhibiting the portion of interest different in mode from the portion of interest of the first image; and generating, based on the region information, the second image including the portion of interest included in the output image.

Further, in the image generating method according to another aspect of the present disclosure, the generating of the second image includes outputting an output image from the SinGAN model. The outputting of the output image includes: inputting a random noise to the generator in at least a lowest layer; and outputting an output image including the portion-of-interest image from the generator in a highest layer.

Further, in the image generating method according to another aspect of the present disclosure, the generating of the second image includes: inputting a random noise to the generator in at least a lowest layer; and outputting the second image from the generator in a highest layer.

Further, in the image generating method according to another aspect of the present disclosure, the portion of interest is a defective portion shown partially on the target object.

Further, according to another aspect of the present disclosure, there is provided a machine learning method including training, based on the second image generated as described above, a machine learning model that receives input of an image obtained by photographing a product and outputs a determination result indicating whether the product is a non-defective product or a defective product including the defective portion.

Further, according to another aspect of the present disclosure, there is provided an image generating device including: a SinGAN model, which is created based on a first image having a portion of interest shown partially on a target object, and includes a generator and a discriminator in each of a plurality of layers; and an input image generating module configured to generate an input image by compositing a target object image and a portion-of-interest image, wherein the image generating device is configured to generate, based on the SinGAN model and the input image, a second image exhibiting a portion of interest different in mode from the portion of interest of the first image.

Further, according to another aspect of the present disclosure, there is provided a program for causing a computer to operate as an image generating device configured to: create a SinGAN model including a generator and a discriminator in each of a plurality of layers based on a first image having a portion of interest shown partially on a target object; generate an input image by compositing a target object image and a portion-of-interest image; and generate, based on the SinGAN model and the input image, a second image exhibiting a portion of interest different in mode from the portion of interest of the first image.

Further, according to another aspect of the present disclosure, there is provided a training image generating method including: creating a SinGAN model including a generator and a discriminator in each of a plurality of layers based on a first training image having a defective portion shown partially on a target object; and generating a second training image exhibiting a defective portion different in mode from the defective portion of the first training image through use of the SinGAN model.

According to the present disclosure, it is possible to facilitate preparation of the images of products in various states and the training images for constructing the image recognition model and to reduce the period of time required for collection of such images.

### BRIEF DESCRIPTION OF THE DRAWINGS

FIG. 1 is a diagram for illustrating an example of a hardware configuration of each of a training image generating device and a machine learning device.

FIG. 2 is a functional block diagram for illustrating an entire configuration of a determination system.

FIG. 3 is a diagram for illustrating a configuration of a SinGAN model.

FIG. 4A, FIG. 4B, and FIG. 4C are diagrams for illustrating conversion of images in a first embodiment of the present disclosure.

FIG. 5A, FIG. 5B, FIG. 5C, and FIG. 5D are diagrams for illustrating the conversion of images in the first embodiment.

FIG. 6 is a flow chart for illustrating a training image generating method.

FIG. 7 is a flow chart for illustrating a method for random generation.

FIG. 8 is a flow chart for illustrating a method of generating an image including a defective portion.

FIG. 9A, FIG. 9B, and FIG. 9C are views for illustrating a GUI in a second embodiment of the present disclosure.

FIG. 10 is a functional block diagram for illustrating an entire configuration of an image generating system.

FIG. 11A, FIG. 11B, and FIG. 11C are diagrams for illustrating conversion of images in a third embodiment of the present disclosure.

FIG. 12A and FIG. 12B are diagrams for illustrating the conversion of images in the third embodiment.

### DESCRIPTION OF THE EMBODIMENTS

Now, at least one preferred embodiment for carrying out the present invention (hereinafter referred to simply as “embodiment”) is described with reference to the drawings. In the following description, like components are denoted by like reference symbols.

### First Embodiment

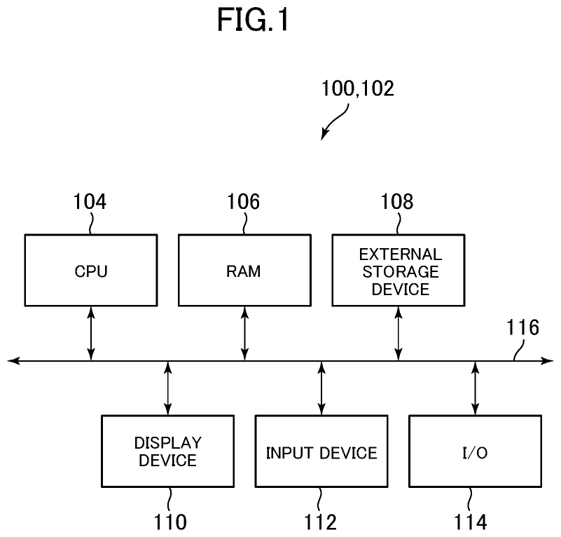

FIG. 1 is a diagram for illustrating an example of a hardware configuration of each of a training image generating device 100 and a machine learning device 102. FIG. 1 shows a general computer, in which a central processing unit (CPU) 104, which is a processor, a random access memory (RAM) 106, which is a memory, an external storage device 108, a display device 110, an input device 112, and input/output (I/O) 114 are connected by a data bus 116 so that electric signals can be exchanged thereamong. The hardware configuration of the computer described above is merely an example, and another configuration may be employed.

The external storage device 108 is a device in which information can be recorded statically, for example, a hard disk drive (HDD) or a solid state drive (SSD). The display device 110 is, for example, a cathode ray tube (CRT) or what is called a flat panel display, and displays an image. The input device 112 is one or a plurality of devices, such as a keyboard, a mouse, and a touch panel, to be used by the user to input information. The I/O 114 is one or a plurality of interfaces to be used by the computer to exchange information with external devices. The I/O 114 may include various ports for wired connection, and a controller for wireless connection.

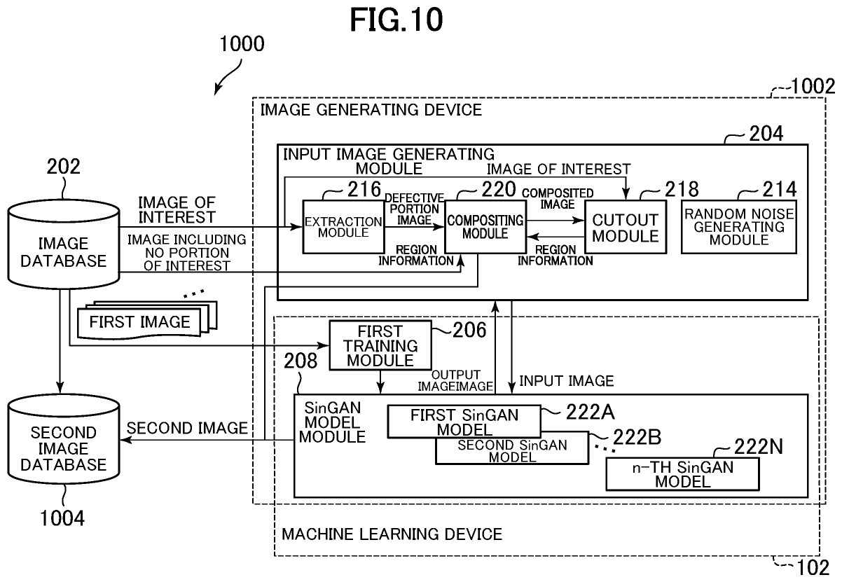

Programs for causing the computer to function as the training image generating device 100, the machine learning device 102, and an image generating device 1002 (see FIG. 10) are stored in the external storage device 108, and are read out by the RAM 106 and executed by the CPU 104 as required. In other words, the RAM 106 stores codes for achieving various functions illustrated as the functional blocks in FIG. 1 by being executed by the CPU 104. Such programs may be provided by being recorded on a computer-readable information recording medium such as an optical disc, a magneto-optical disk, or a flash memory, or may be provided via the I/O 114 through an external information communication line such as the Internet.

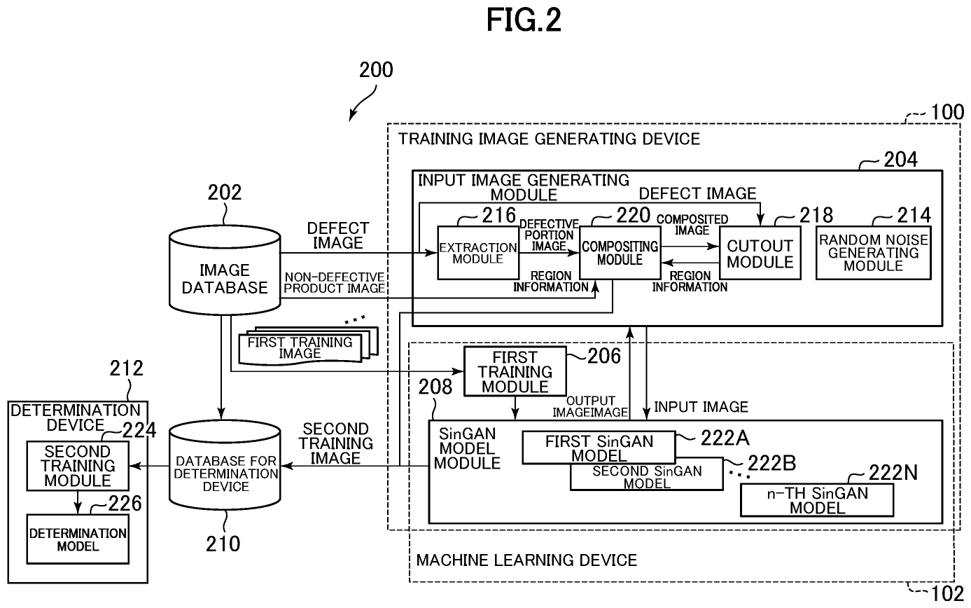

FIG. 2 is a functional block diagram for illustrating an entire configuration of a determination system 200 in the first embodiment of the present disclosure. As illustrated in FIG. 2, the determination system 200 includes an image database 202, an input image generating module 204, a first training module 206, a SinGAN model module 208, a database 210 for a determination device, and a determination device 212. Further, the training image generating device 100 includes the input image generating module 204, the first training module 206, and the SinGAN model module 208. The machine learning device 102 includes the first training module 206 and the SinGAN model module 208. The “machine learning device 102” herein refers to a device that executes training of the SinGAN model module 208 through use of a first training image, and the “training image generating device 100” herein refers to a device that generates a second training image being teaching data to be used for training a determination model 226 to be subjected to supervised learning.

The SinGAN model module 208 includes one or a plurality of SinGAN models (see Tamar Rott Shaham, Tali Dekel, and Tomer Michaeli, SinGAN: Learning a Generative Model from a Single Natural Image, Proceedings of the IEEE International Conference on Computer Vision, 2019). In FIG. 2, a case in which the SinGAN model module 208 includes “n” SinGAN models of from a first SinGAN model 222A to an n-th SinGAN model 222N is illustrated, but the following description is mainly directed to a case in which the SinGAN model module 208 includes the first SinGAN model 222A and a second SinGAN model 222B.

Further, the “first training image” is one form of a first image described later (see a third embodiment of the present disclosure), and is teaching data to be used for training the SinGAN model in the first embodiment. The “second training image” is one form of a second image (see the third embodiment), and is teaching data to be used for training an image recognition model (for example, a machine learning model implemented in an inspection device used for visual inspection). Further, a case in which images in each of which a defective portion is shown partially on a target object are used as examples of the first training image and the second training image is described.

Further, the target object is, for example, a product to be inspected in an inspection process at a factory, such as a casting formed by pouring a material into a mold. The defective portion is one form of a portion of interest described later (see the third embodiment), and examples thereof include a flaw, chipping, and a porosity (cavity caused by a change in volume at a time of solidification from a molten state) that has appeared on a surface of the product. The determination device 212 is described by using as an example thereof a device that determines whether or not a flaw, chipping, or a porosity has been caused on a casting formed by pouring a material into a mold in an inspection process at a factory.

Further, an image input to the SinGAN model is referred to as “input image,” and an image output from the SinGAN model is referred to as “output image.” In addition, images in which a defective portion is shown are referred to as “defect images” as a whole, and an image obtained by extracting only the defective portion from the defect image is referred to as “defective portion image.” Further, an image in which a target object (non-defective product) having no defective portion formed thereon is shown is referred to as “non-defective product image.” Further, images in which a target object is shown are referred to as “target object images” as a whole irrespective of whether the target object is a non-defective product or a defective product.

The image database 202 is a database that stores a plurality of photographed non-defective product images and at least one photographed defect image. Specifically, for example, the image database 202 stores a non-defective product image and a defect image that have been acquired through photographing during a visual inspection process. In general, more non-defective products are manufactured than defective products during a product manufacturing process. Thus, the image database 202 stores more non-defective product images than defect images. The image database 202 stores defect images the number of which is equal to or larger than the number of SinGAN models to be trained. The image database 202 may be, for example, a storage device included in a computer that manages the entire manufacturing process or a storage device included in a computer that can communicate, through a network, to/from a photographing unit that acquires the non-defective product image and the defect image through photographing.

The first training module 206 included in the machine learning device 102 trains the SinGAN model through use of the first training image. The training image generating device 100 uses the trained SinGAN model to generate a second training image exhibiting a defective portion different in mode from that of the first training image. When the SinGAN model module 208 includes a plurality of SinGAN models, the first training module 206 trains the respective SinGAN models through use of mutually different first training images. In this case, the training image generating device 100 uses each trained SinGAN model to generate a second training image exhibiting a defective portion different in mode from that of each first training image used for the corresponding training.

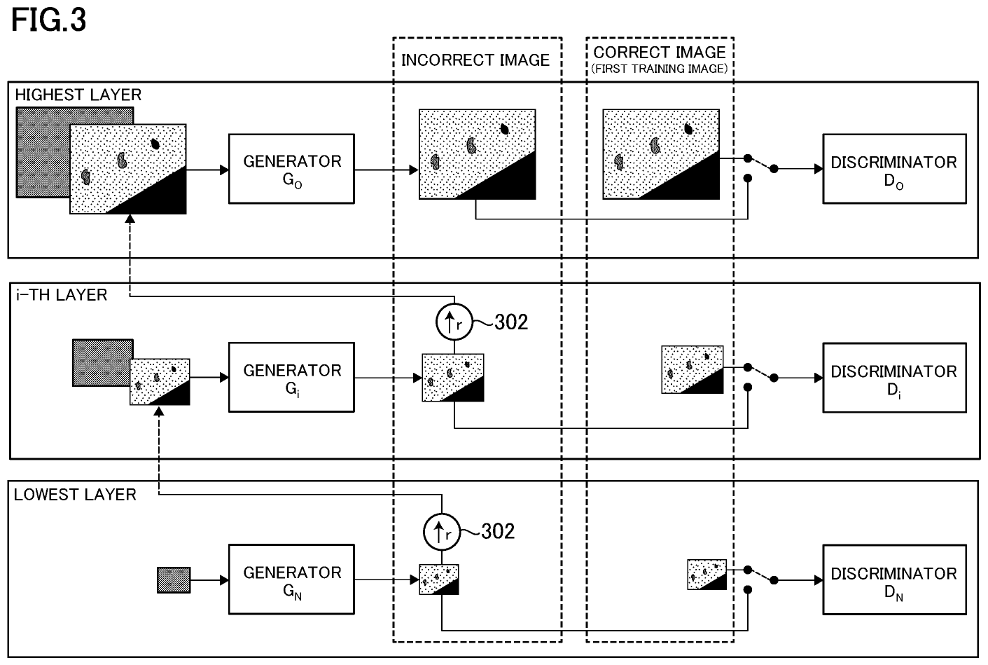

The SinGAN model is a machine learning model that receives an input image and generates a second training image exhibiting a defective portion different in mode from that of the first training image used for training. Specifically, FIG. 3 is a diagram for illustrating a configuration of one SinGAN model. The SinGAN model itself is known, and hence the description thereof is kept to a minimum.

As illustrated in FIG. 3, the SinGAN model is formed of a plurality of layers each including a generative adversarial network (GAN). The number of layers may be any number that is equal to or larger than two. Each GAN includes two neural networks called “generator” and “discriminator.” The generator and the discriminator that are included in a highest layer are a generator G₀ and discriminator D₀, respectively. The generator and the discriminator that are included in an i-th layer are a generator Gᵢ and a discriminator Dᵢ, respectively. The generator and the discriminator that are included in a lowest layer are a generator G_{N} and a discriminator DN, respectively. In addition, the layers except the highest layer each include an upsampler 302 that increases a resolution of an image output by the generator.

The generator included in each layer generates an image having a defective portion shown partially on a target object and being difficult to be distinguished from the first training image. Specifically, the generator G_{N} receives input of a random noise having a predetermined size. Then, the generator G_{N} outputs an image having a defective portion shown partially on a target object and having the same size as that of the random noise. Meanwhile, the discriminator DN receives input of both an image (incorrect image) having a defective portion shown partially on a target object, which has been generated by the generator G_{N}, and a first training image (correct image) downsampled (reduced in resolution) to the same size as that of the random noise input to the generator G_{N}. In addition, the upsampler 302 increases the resolution of the image output by the generator G_{N}, and outputs the upsampled image to a generator G_{N-1} in the immediately higher layer.

The generator in each layer except the lowest layer receives input of an image output by the upsampler 302 in the immediately lower layer and a random noise having the same resolution as that of the output image. Then, the generator in each layer outputs an image having the same size as that of the input image. Meanwhile, the discriminator in each layer receives input of both an image (incorrect image) having a defective portion shown partially on a target object, which has been generated by the generator in the same layer, and a first training image (correct image) downsampled (reduced in resolution) to the same size as that of the incorrect image.

The output of the discriminator in each layer serves to discriminate whether the input data is an incorrect image or a correct image. Then, the first training module 206 performs training in order from the lowest layer to the highest layer so that the discriminator included in each layer correctly discriminates those two images and so that the generator inhibits the discriminator to discriminate those two images.

The SinGAN model having the above-mentioned configuration can execute learning through use of a single first training image. In addition, the SinGAN model receives input of an image having the smaller size in the lower layer and receives input of an image having the larger size in the higher layer. The SinGAN model has a feature that while an image having an appearance closer to that of a training image is generated in the lower layer, an image having an appearance that is more unlikely to be changed from that of an input image is generated in the higher layer. Thus, when an input image described later is input to the generator in an appropriately selected layer, it is possible to generate an image-style-converted image resulting from conversion of the input image in terms of a hue and the like while maintaining a region of a defective portion shown in the input image.

The input image generating module 204 includes a random noise generating module 214, an extraction module 216, a cutout module 218, and a compositing module 220. The random noise generating module 214 generates a random noise having a predetermined resolution. The predetermined resolution herein refers to a resolution that can be received by the generator in each of the layers included in the SinGAN model. The random noise generating module 214 appropriately generates a random noise having a resolution corresponding to the layer of the generator.

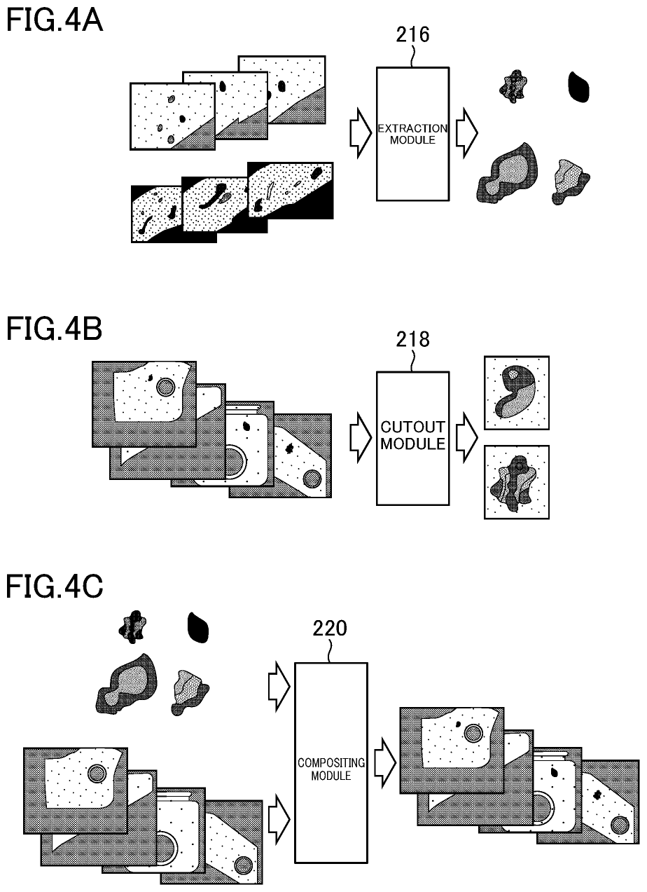

The extraction module 216 receives input of a defect image, and extracts therefrom a defective portion image, which is an image of only a defective portion shown in the defect image. Specifically, for example, as illustrated in FIG. 4A, the extraction module 216 receives input of defect images in which defective portions are shown partially on various target objects. The defect image may be an image obtained by actually photographing a target object on which a defect has been formed, or may be an image generated by a trained SinGAN model by inputting a random noise to the SinGAN model. Then, the extraction module 216 extracts only a region in which a defective portion is shown from the defect image as the defective portion image. The number of defect images to be input to the extraction module 216 and the number of defective portion images to be extracted by the extraction module 216 are freely set.

The cutout module 218 receives input of an image in which a defective portion is shown partially on a target object, and cuts out a region of the defective portion and a periphery of the defective portion. Specifically, for example, as illustrated in FIG. 4B, when the cutout module 218 receives input of photographed defect images or defect images composited by the compositing module 220, the cutout module 218 cuts out a fixed region including a defective portion shown in each defect image. In this case, the cutout module 218 cuts out an image having a size suitable for the generator in the highest layer of a trained SinGAN model. A size for the cutout is not required to match the size of an image received by the generator in the highest layer. It suffices that, for example, the size for the cutout is a size close to the size of an image received by the generator in the highest layer (for example, is a size with a scaling ratio of within 10%). When the input image includes a plurality of defective portions, the cutout module 218 may perform the cutout so as to include all the defective portions, or may perform the cutout so as to include only some of the defective portions. The image cut out by the cutout module 218 is resized to a size suitable for the generator in an intermediate layer of the SinGAN model and is then input to the generator. The cutout module 218 may also acquire region information representing a region of the cut-out image in the image before the cutout (hereinafter also referred to as “overall image”).

The compositing module 220 composites a target object image and a defective portion image. Specifically, for example, as illustrated in FIG. 4C, the compositing module 220 overwrites a partial region in each non-defective product image with a defective portion image extracted by the extraction module 216, to thereby composite the non-defective product image and the defective portion image. The non-defective product image is an image obtained by actually photographing each of various target objects having no defective portion formed thereon, or an image of a target object including no defective portion, which has been generated by publicly known means. The compositing module 220 may change the defective portion image in size, aspect ratio, hue, and angle before compositing and then composite the changed defective portion image with the non-defective product image. Further, the region in which the defective portion image is pasted may be any region in which the target object is shown in the non-defective product image.

Further, the compositing module 220 may acquire region information on the defective portion. Specifically, when the compositing module 220 composites the non-defective product image and the defective portion image, the compositing module 220 may acquire region information representing a region occupied by the defective portion image in the composited image. When the defective portion image is changed in size, aspect ratio, and angle during compositing, the region information is information representing a region in which the changed defective portion image has been pasted in the composited image.

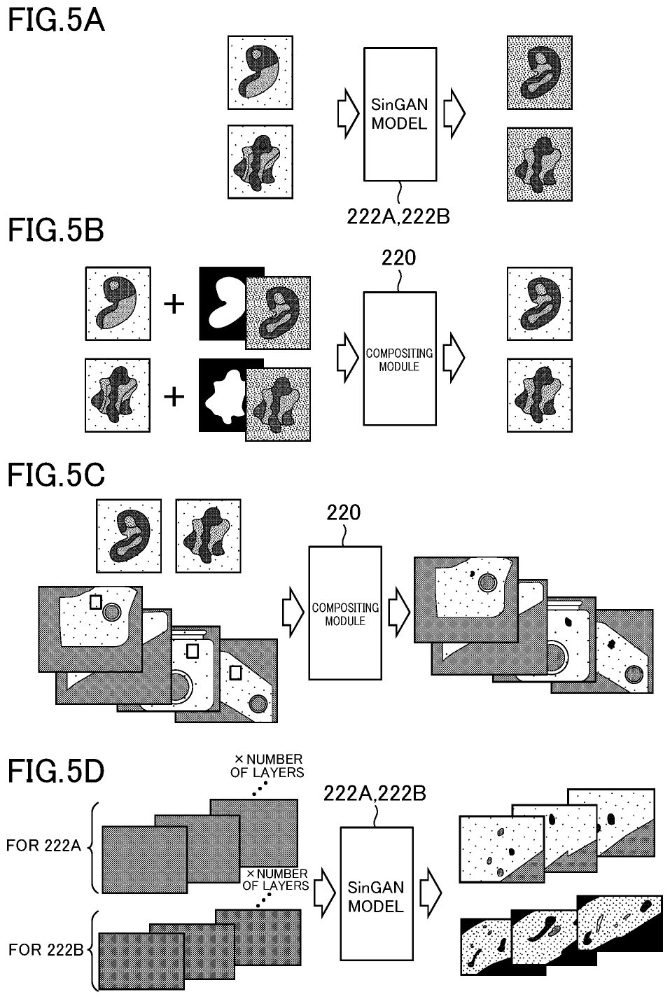

When the region information is acquired, an image including the defective portion image included in an output image output from the generator may be generated based on the region information. Specifically, for example, as illustrated in FIG. 4B, the cutout module 218 first cuts out input images from overall images and also acquires the region information. Subsequently, as illustrated in FIG. 5A, the SinGAN models 222A and 222B have the cut-out images input to the generator, and output images subjected to image style conversion processing (output images).

Then, as illustrated in FIG. 5B, the compositing module 220 may composite a region excluding the defective portion in each input image and a region of the defective portion in each output image based on the above-mentioned region information. Thus, it is possible to generate an image in which only the region of the defective portion has been replaced by an image generated by the SinGAN model from a peripheral image of the defective portion.

In addition, the compositing module 220 may composite the image before being cut out by the cutout module 218 and the image composited by the compositing module 220 based on the region information. Specifically, as described above, the region information is information representing the region of the cut-out image in the image before being cut out by the cutout module 218. As illustrated in FIG. 5C, the compositing module 220 composites the image composited by the compositing module 220 with the region represented by the region information on the image before being cut out by the cutout module 218. Thus, it is possible to generate an image in which only the region of the defective portion has been replaced by an image generated by the SinGAN model.

The database 210 for the determination device is a database that stores a plurality of non-defective product images, at least one defect image, and second training images. Specifically, for example, the database 210 for the determination device stores all the non-defective product images and defect images stored in the image database 202 and the second training images generated by the training image generating device 100. The database 210 for the determination device may be, for example, a storage device included in a computer that manages the entire manufacturing process, or may be a storage device included in a computer that can communicate to/from the determination device 212 through the network.

The determination device 212 includes a second training module 224 and the determination model 226. Specifically, for example, the determination device 212 is a device that determines whether or not a flaw, chipping, or a porosity has been caused on a casting formed by pouring a material into a mold in an inspection process at a factory.

The second training module 224 included in the determination device 212 trains the determination model 226 through use of the images stored in the database 210 for the determination device. The determination model 226 is a machine learning model that receives input of an image of a product photographed in an inspection process and outputs a determination result indicating whether the product is a non-defective product or a defective product. The determination model 226 may be a publicly known machine learning model, and examples thereof include a convolutional neural network (CNN). When the trained determination model 226 receives input of an image of a product photographed in an inspection process, the determination model 226 outputs a determination result indicating whether or not a defective portion is shown in the image of the product.

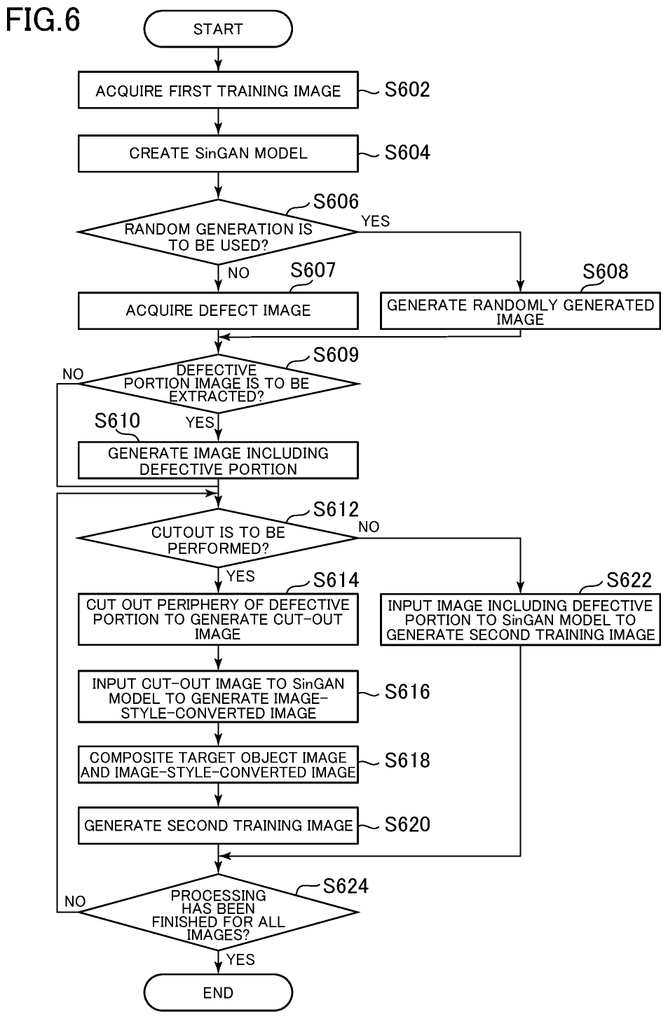

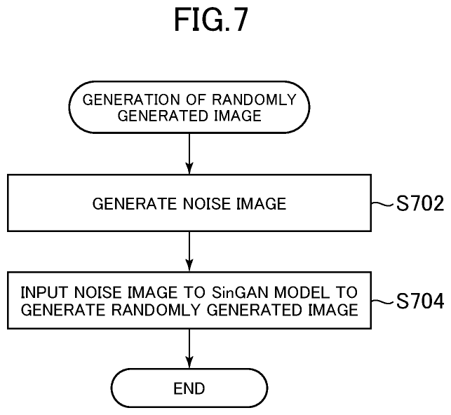

FIG. 6 and FIG. 7 are flow charts for illustrating a training image generating method performed by the training image generating device 100 according to the first embodiment. First, a first training image used for creating a SinGAN model is acquired (Step S602). Specifically, the first training module 206 acquires, from the image database 202, at least one of defect images in which defective portions are shown partially on various target objects. As described above, it is preferred that the defect image be an image obtained by actually photographing a target object on which a defect has been formed, but when there is a SinGAN model that has already been trained, the defect image may be an image generated by the trained SinGAN model by inputting the random noise to the trained SinGAN model. Further, a plurality of first training images may be acquired, and the description is given herein on the assumption that two first training images have been acquired.

Subsequently, the first training module 206 executes training of the SinGAN model (Step S604). The first training module 206 uses the two first training images acquired in Step S602 to train the generators and discriminators in the respective layers in order from the lowest layer to the highest layer by the above-mentioned training method. In the above description, two first training images have been acquired, and hence the first training module 206 uses a first one of the first training images to execute training of the first SinGAN model 222A, and uses a second one of the first training images to execute training of the second SinGAN model 222B. In this case, the first one of the first training images and the second one of the first training images differ from each other, and hence the first SinGAN model 222A and the second SinGAN model 222B differ from each other.

Subsequently, when random generation is not to be performed, the process proceeds to Step S607, and when the random generation is to be performed, the process proceeds to Step S608 (Step S606). The random generation herein refers to inputting a random noise to a trained SinGAN model and randomly generating a defect image. It may be appropriately selected by a user whether or not the random generation is to be performed.

In Step S607, the input image generating module 204 acquires, from the image database 202, one or a plurality of defect images in which defective portions are shown partially on various target objects. The defect image is an image obtained by actually photographing a target object on which a defect has been formed.

Meanwhile, in Step S608, the random generation is performed. FIG. 7 is a flow chart for illustrating a method for the random generation. Specifically, first, the random noise generating module 214 generates such random noises as illustrated in FIG. 5D (Step S702). The generated random noises are each generated so as to have the size of an image suitable for at least the generator in the lowest layer of the SinGAN model. In FIG. 5D, three times as many random noises as the layers of the first SinGAN model 222A are generated for the first SinGAN model 222A, and three times as many different random noises as the layers of the second SinGAN model 222B are generated for the second SinGAN model 222B, but the number of random noises to be generated may be appropriately set in accordance with the number of required second training images.

Subsequently, the generated random noise is input to the trained SinGAN model (Step S704). Specifically, for example, as illustrated in FIG. 5D, the generated random noises for the first SinGAN model 222A are input to the generators G₀ to G_{N} in all the layers of the first SinGAN model 222A that has already been trained in Step S604. The first SinGAN model 222A outputs three defect images from the generator G₀ in the highest layer. In the same manner, the remaining generated random noises for the second SinGAN model 222B are input to the generators G₀ to G_{N} in all the layers of the second SinGAN model 222B that has already been trained in Step S604. The second SinGAN model 222B outputs three defect images from the generator G₀ in the highest layer.

In this case, when different random noises are input to the same SinGAN model, images in which target objects appear closer to that of the first training image used for training in terms of hue, size, and the like are output in spite of differences in number, size, and the like of defective portions. In addition, the first SinGAN model 222A and the second SinGAN model 222B have been trained through use of different first training images. Thus, as indicated by the output images illustrated in the upper stage and lower stage of FIG. 5D, three defect images generated by the first SinGAN model 222A differ from three defect images generated by the second SinGAN model 222B in image style including the hue and size of the target object.

When the random generation is to be used, before or after Step S608, a defect image acquired from the image database 202 may be acquired in addition to the defect image generated through use of the SinGAN model. In this case, the second training images are generated based on both the photographed defect image and the generated defect image.

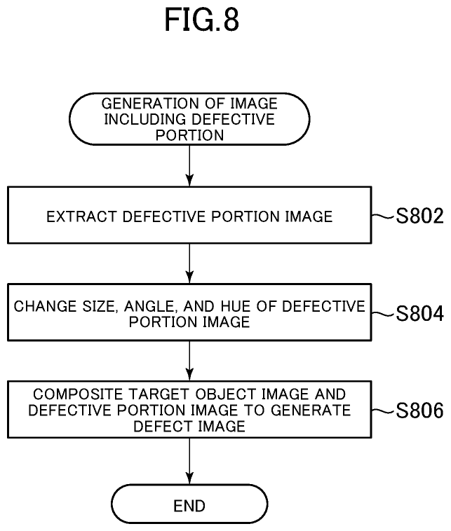

After the defect image is obtained in Step S607 or generated in Step S608, the process proceeds to Step S610 when the defective portion image is to be extracted, and proceeds to Step S612 when the defective portion image is not to be extracted (Step S609). In Step S610, after the extraction module 216 extracts the defective portion image, an image including a defective portion is generated. FIG. 8 is a flow chart for illustrating a method of extracting the defective portion image. The extraction module 216 receives input of a defect image, and extracts a defective portion image, which is an image of only a defective portion shown in the defect image (Step S802). Specifically, for example, as illustrated in FIG. 4A, the extraction module 216 receives input of the defect image acquired in Step S607 or the defect image generated in Step S608, and extracts, as the defective portion image, only a region in which a defective portion is shown. In FIG. 4A, only the defective portion images showing some of the defective portions included in six defect images are extracted, but the extraction module 216 may extract the defective portion images showing all the defective portions included in the input defect images.

Subsequently, the compositing module 220 changes the size, angle, and hue of the extracted defective portion image (Step S804). The size, angle, and hue are appropriately changed through use of a publicly known technology.

Subsequently, the compositing module 220 composites the non-defective product image and the defective portion image (Step S806). Specifically, for example, as illustrated in FIG. 4C, the compositing module 220 acquires the non-defective product image from the image database 202. Then, the compositing module 220 overwrites a partial region in the acquired non-defective product image with the defective portion image extracted by the extraction module 216, to thereby composite the non-defective product image and the defective portion image. At this time, the compositing module 220 acquires the region information representing a region occupied by the defective portion image in the composited image.

Subsequently, the process proceeds to Step S614 when image cutout is to be performed, and proceeds to Step S622 when the image cutout is not to be performed (Step S612). The image cutout herein refers to processing for cutting out the region of the defective portion and the periphery of the defective portion, which is performed by the cutout module 218. Step S612 to Step S624 are repeatedly executed as many times as the number of defect images acquired or generated from Step S607 to Step S610. For example, when six defect images have been acquired in Step S608, Step S612 to Step S624 are executed six times.

It may be appropriately selected by the user whether or not the image cutout is to be performed. For example, the selection may be performed based on a proportion of the defective portion to the defect image. Specifically, the image cutout may be performed when the size of the defective portion is less than 30% of the entire defect image without performing the image cutout when the size is 30% or more. In the image style conversion processing of Step S616, when the proportion of the defective portion to the defect image is too small, there is little difference between images before and after the image style conversion processing. Through the selection of whether or not to perform the cutout based on the proportion, the image style conversion processing of Step S616 enables generation of a defect image in which a defective portion in a mode that is not included in the image database 202 is shown.

When the defect image is input to the cutout module 218, as illustrated in FIG. 4B, the cutout module 218 cuts out a fixed region including the defective portion shown in the defect image (Step S614). In this case, the cutout module 218 cuts out the image having a size suitable for the generator in the highest layer of the trained SinGAN model. The size for the cutout is not required to match the size of the image received by the generator in the highest layer. The cut-out image is used as the input image to the SinGAN model. The cutout module 218 also acquires the region information representing the region of the cut-out image in the image before the cutout. Then, the cutout module 218 resizes the cut-out image to a size suitable for the generator in the predetermined intermediate layer among a plurality of layers and inputs the resized image.

Subsequently, the SinGAN model generates an output image obtained by performing the image style conversion processing on the input image (Step S616). Specifically, for example, as illustrated in FIG. 5A, the SinGAN model generates an output image obtained by performing the image style conversion processing on the input image from the generator G₀ in the highest layer.

In this case, when the input image is an image generated through use of a SinGAN model or a part of the image, the input image is input to a SinGAN model different from the SinGAN model used for generating the input image. Specifically, for example, when the input image is a defect image generated through use of the first SinGAN model 222A in Step S608 or an image cut out from the defect image, the input image is input to the second SinGAN model 222B. When the input image is a defect image generated through use of the second SinGAN model 222B in Step S608 or an image cut out from the defect image, the input image is input to the first SinGAN model 222A. Through use of a SinGAN model different from the SinGAN model that generates the input image, it is possible to generate an output image in which the image style of the input image has been changed.

Subsequently, as illustrated in FIG. 5C, the compositing module 220 composites the region excluding the defective portion in the input image and the region of the defective portion in the output image based on the region information (Step S618). In this case, the region in which the defective portion shown in the input image is represented by the region information acquired in Step S806 and Step S614. When the composite image is generated in Step S618, the region of the defective portion in the input image and the region of the defective portion in the output image are required to match each other. Thus, in Step S616, the generator in an intermediate layer in which the image style conversion is performed to such an extent that the region in which the defective portion shown in the input image is not changed is selected. That is, the layer of the generator to which the cut-out image is to be input is determined based on a layout of the defective portion shown in the input image. In other words, through the determination of the intermediate layer to which the cut-out image is to be input based on the layout of the defective portion, it is possible to perform the image style conversion to such an extent that the region in which the defective portion shown in the input image is not changed.

Subsequently, the compositing module 220 composites the image before being cut out by the cutout module 218 in Step S614 and the image composited by the compositing module 220 in Step S618 based on the region information acquired in Step S614, to thereby generate a second training image (Step S620). At this time, when the size of the image cut out in Step S614 and the size of the image composited by the compositing module 220 in Step S618 differ from each other, the compositing module 220 may enlarge or reduce the composited image based on the region information acquired in Step S614.

In Step S612, when the image cutout is not to be performed, the defect image acquired in Step S607 or the defect image generated in Step S608 or Step S610 is input to a SinGAN model. Then, the SinGAN model generates, as the second training image, an output image obtained by performing the image style conversion processing on the input image from the generator G₀ in the highest layer (Step S622). Even when the image cutout is not to be performed, the defect image may be input after being resized in accordance with an input size of the generator in the intermediate layer. Further, in the same manner as in Step S616, the SinGAN model used in Step S622 is a SinGAN model different from the SinGAN model used for generating the input image.

As is apparent from the example of a porosity caused on a casting illustrated in the first embodiment, it is not easy to actually prepare a sufficient number of appropriate training images for training a neural network model. In order to acquire training images in which various different defective modes are shown, it is required to achieve the various different defective modes, which requires too much time and cost and is thus not realistic. However, according to the first embodiment, a large number of training images different in defective mode can be easily created. For example, at a time of starting up a new visual inspection process, a period of time required for the startup is shortened.

In FIG. 2, a configuration in which the machine learning device 102 is a part of the training image generating device 100 is illustrated as an example, but the training image generating device 100 and the machine learning device 102 may be physically separately prepared as individual devices. Further, the training image generating device 100 and the machine learning device 102 may be incorporated as parts of another machine or device, or may be appropriately configured, as the requirement arises, through use of physical configurations of other machines or devices. More specifically, the training image generating device 100 and the machine learning device 102 may be implemented in a software manner through use of a general-purpose computer.

Further, the programs that cause the computer to operate as the training image generating device 100 and the machine learning device 102 may be integrated or may be executed separately independently. Further, the programs may be incorporated into other software as modules. Further, the training image generating device 100 and the machine learning device 102 may be constructed on a so-called server computer, and only functions thereof may be provided to remote sites through public telecommunication lines such as the Internet.

### Second Embodiment

Next, an image generating method according to a second embodiment of the present disclosure is described. The image generating method according to the second embodiment is a method of generating a training image in the same manner as in the first embodiment. In the second embodiment, in place of the steps of from Step S606 to Step S610 in the first embodiment, the user designates a shape of a defective portion, to thereby generate an image including a defective portion having a freely-selected shape. Other steps of the image generating method according to the second embodiment are the same as those in the first embodiment.

First, a SinGAN model is created and trained. Those steps are the same as Step S602 and Step S604 included in the first embodiment.

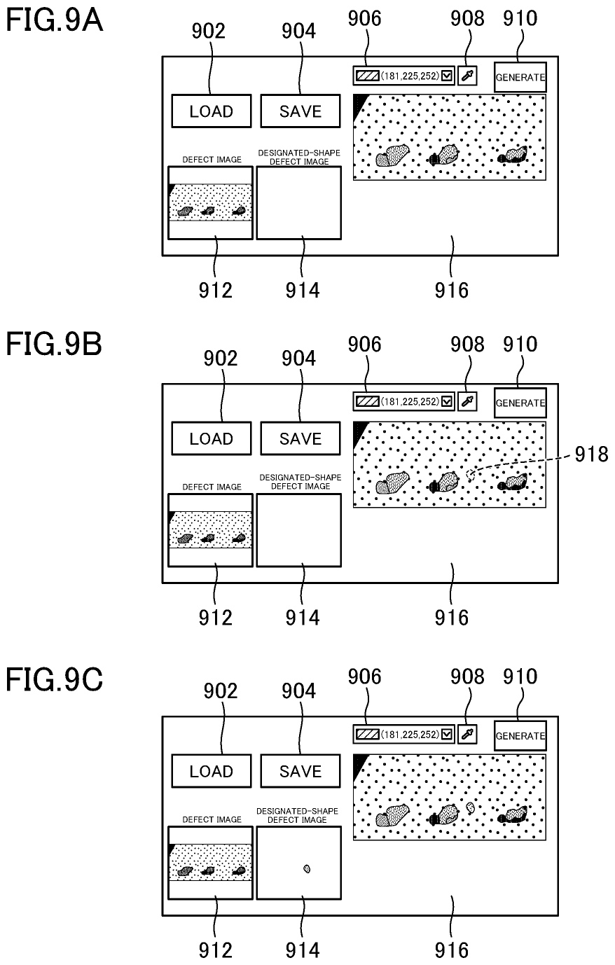

Subsequently, a defect image having the shape designated by the user is generated. Specifically, description is given with reference to FIG. 9A to FIG. 9C. FIG. 9A to FIG. 9C are examples of a graphical user interface (GUI) displayed on the display device 110 when the user instructs the computer to execute a program for generating a defective portion image having a freely-selected shape. As illustrated in FIG. 9A to FIG. 9C, a load button 902, a save button 904, a color designation dropdown button 906, an eyedropper button 908, a generate button 910, a defect image field 912, a designated-shape defect image field 914, and a shape designation field 916 are displayed on the GUI.

First, the user designates a defect image. Specifically, for example, the user clicks the load button 902 to designate the defect image stored in the image database 202. As illustrated in FIG. 9A, the designated defect image is displayed in the defect image field 912 and the shape designation field 916. The designated image is herein a defect image that has been used for training a SinGAN model, but is not limited thereto, and may be another defect image.

Subsequently, the user designates a color. Specifically, for example, the user operates the color designation dropdown button 906 to select a color displayed in a list, to thereby designate the color. In this case, the color to be designated is a color close to a color of a defective portion included in an image used for training a SinGAN model 222. The color close to the color of the defective portion is, for example, a color that is spaced apart from the color of the defective portion on chromaticity coordinates by a distance equal to or less than a predetermined value. The user may also operate the eyedropper button 908 to select any spot on the defective portion shown in the defect image in the shape designation field 916. The color of the defect image at the selected spot is set as the color designated by the user. The color may be represented by gradations of, for example, red, green, and blue, and the user may designate the color by inputting a numerical value for each of the gradations.

Subsequently, the user designates a shape. Specifically, for example, the user designates a desired shape by dragging a mouse in the shape designation field 916. A broken line 918 illustrated in the shape designation field 916 of FIG. 9B is an example of the shape designated by the user.

Subsequently, the user generates a defective portion image. Specifically, the user clicks the generate button 910. When the generate button 910 is clicked, as illustrated in FIG. 9C, the designated color is applied to a region surrounded by the broken line 918 in the shape designation field 916, and an image having the designated shape with the designated color applied thereto is displayed in the designated-shape defect image field 914. In addition, when the user clicks the save button 904, the image displayed in the designated-shape defect image field 914 is saved as the defective portion image. The saved defective portion image corresponds to the defective portion image extracted by the extraction module 216 in Step S802 included in Step S610 in the first embodiment.

Then, the compositing module 220 rotates the generated defective portion image, and composites the non-defective product image and the rotated defective portion image. Those steps are the same as Step S804 and Step S806 in the first embodiment. With the above-mentioned steps, a defect image is generated by compositing a non-defective product image with an image having any shape desired by the user and having a color close to the color of the defective portion included in the image used for training.

The subsequent steps are the same as the steps of from Step S612 to Step S624 in the first embodiment, and hence description thereof is omitted. As described above, it is possible to designate the shape and the color while viewing the defective portion shown in the defect image, and hence the user can generate a defective portion image in which a defective portion having a shape that has not actually occurred is shown.

### Third Embodiment

Subsequently, an image generating system 1000 and an image generating method according to the third embodiment are described. The image generating system 1000 and the image generating method according to the third embodiment are an apparatus and a method for generating images that can be applied not only for learning purposes but also for other purposes unlike in the first embodiment. Description of the same point as in the first embodiment is omitted.

FIG. 10 is a functional block diagram for illustrating an entire configuration of the image generating system 1000 in the third embodiment of the present disclosure. As illustrated in FIG. 10, the image generating system 1000 includes the image database 202, the input image generating module 204, the first training module 206, the SinGAN model module 208, and a second image database 1004. Further, the image generating device 1002 includes the input image generating module 204, the first training module 206, and the SinGAN model module 208. The machine learning device 102 includes the first training module 206 and the SinGAN model module 208. The “machine learning device 102” herein refers to a device that executes the training of the SinGAN model module 208 through use of a first image, and the “image generating device 1002” herein refers to a device that generates a second image.

Further, the “first image” is teaching data to be used for training a SinGAN model in the present embodiment. The “second image” is an image generated by the image generating device 1002 with the generated image itself being used as it is or after being processed. Further, a case in which an image having a portion of interest shown partially on a target object is used as an example of the first image and the second image is described.

Further, the target object is, for example, a product manufactured at a factory or a store, examples of which include food products such as a pizza, a mashed potato, a salad, and a cake and industrial products such as tableware. The second image is described by using as an example thereof an image to be displayed on a menu table presented at a restaurant, in which various ingredients are placed on a pizza.

In addition, images in which a portion of interest is shown are referred to as “images of interest” as a whole, and an image obtained by extracting only the portion of interest from the image of interest is referred to as “portion-of-interest image.” Further, an image in which a target object including no portion of interest is shown is referred to as “image including no portion of interest.” Further, images in which a target object is shown are referred to as “target object images” as a whole irrespective of whether or not a portion of interest is included.

The image database 202 is a database that stores a plurality of photographed images including no portion of interest and at least one photographed image of interest. Specifically, for example, the image database 202 stores an image of only dough of a pizza and an image of a baked whole or pieces of pizza with ingredients placed thereon that were acquired through photographing during a manufacturing process.

The first training module 206 and the SinGAN model module 208 are the same as those in the first embodiment. As the first image used for training, not an image of only the dough but an image of a baked pizza with ingredients placed thereon is used.

The input image generating module 204 includes the random noise generating module 214, the extraction module 216, the cutout module 218, and the compositing module 220. The functions of the respective module are the same as those in the first embodiment except that the extraction module 216 extracts the portion-of-interest image in place of the defective portion image and that the extraction module 216 and the cutout module 218 cut out the image of interest in place of the defect image.

The second image database 1004 is a database that stores generated second images. The second image database 1004 may be omitted, and the image database 202 may store the generated second images.

Further, in the third embodiment, the generated image is not required to be used for the training. Thus, the image generating system 1000 according to the third embodiment does not include the determination device 212.

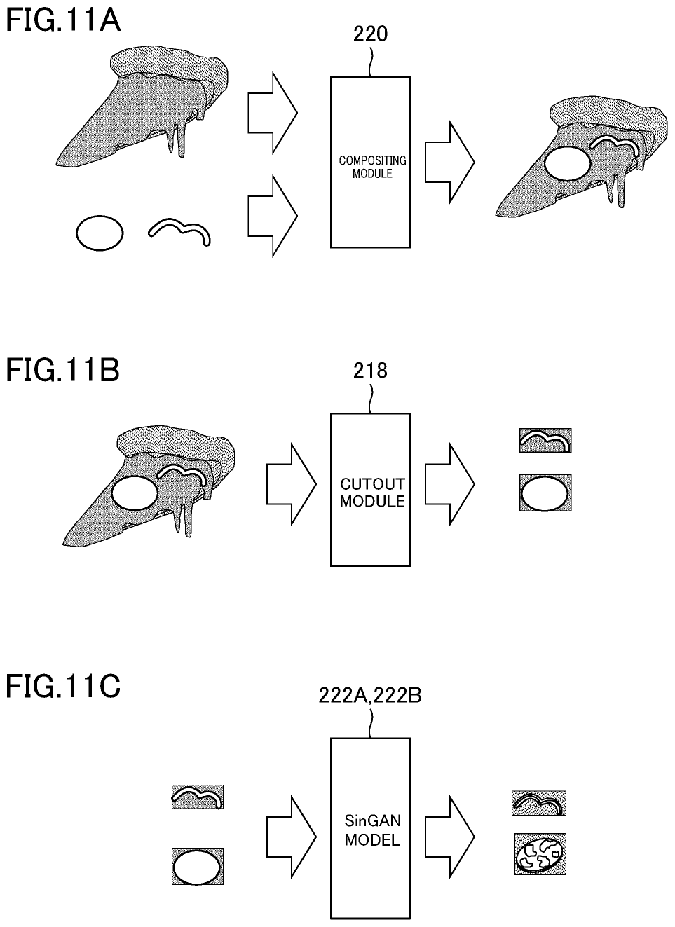

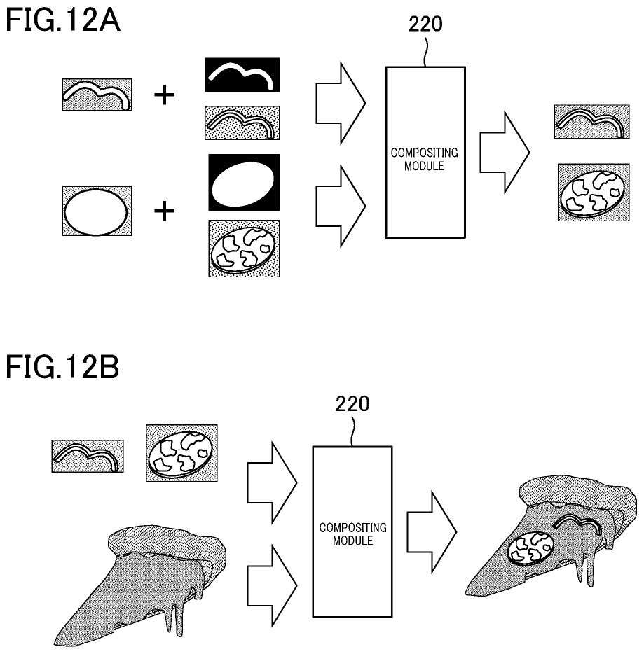

An image generating method performed by the image generating device 1002 according to the third embodiment is described with reference to FIG. 11A to FIG. 12B. In the third embodiment, a case in which an input image is generated by cutting out a region of the portion of interest and a periphery of the portion of interest from a composited image at the time of generating the input image is described.

First, a SinGAN model including a generator and a discriminator in each of a plurality of layers is created based on a first image having a portion of interest shown partially on a target object. Those steps are the same as Step S602 and Step S604 included in the first embodiment except that the training is performed through use of the first image. As described above, as the first image to be used for learning, an image of a baked pizza with ingredients placed thereon is used in place of an image of only dough. In this case, a SinGAN model trained by setting images of pizzas with only pieces of bell pepper placed thereon as the first images is set as the first SinGAN model 222A. Meanwhile, a SinGAN model trained by setting images of pizzas with only slices of salami placed thereon as the first images is set as the second SinGAN model 222B.

Subsequently, a portion-of-interest image having a shape designated by the user is generated. Specifically, in the same manner as in the second embodiment, images having shapes and colors desired by the user and imitating ingredients placed on a pizza are generated. At the bottom left of FIG. 11A, a green image having such a shape like the number “3” as to simulate a piece of bell pepper and a light red image having such an elliptical shape as to simulate a slice of salami are shown as the generated portion-of-interest images. The images are portion-of-interest images created by the user through use of the GUI illustrated in FIG. 9A to FIG. 9C.

Subsequently, the compositing module 220 composites the target object image and the portion-of-interest images, to thereby generate an input image. Specifically, the compositing module 220 acquires an image including no portion of interest from the image database 202. Then, the compositing module 220 overwrites a partial region in the acquired image including no portion of interest with the portion-of-interest images created by the user through use of the GUI, to thereby composite the image including no portion of interest and the portion-of-interest images. As illustrated in FIG. 11A, the compositing module 220 composites the image simulating a piece of bell pepper and the image simulating a slice of salami with the image of only dough. At this time, the compositing module 220 acquires the region information representing regions occupied by the portion-of-interest images in the composited image.

Subsequently, the cutout module 218 cuts out a fixed region including a portion of interest shown in each image of interest. This step is the same as Step S614 in the first embodiment. Thus, as illustrated in FIG. 11B, images of interest obtained by adding backgrounds to the image simulating a piece of bell pepper and the image simulating a slice of salami that have been created by the user are generated.

Subsequently, an input image is input to a SinGAN model to generate an output image exhibiting a portion of interest different in mode from that of the first image. That is, the SinGAN model generates an output image obtained by performing the image style conversion processing on an input image. This step is the same as Step S616 in the first embodiment. Specifically, as illustrated in FIG. 11C, the first SinGAN model 222A to which the image simulating a piece of bell pepper has been input generates an output image including the piece of bell pepper subjected to the image style conversion processing. Meanwhile, the second SinGAN model 222B to which the image simulating a slice of salami has been input generates an output image including the slice of salami subjected to the image style conversion processing. Thus, it is possible to generate images of interest having shapes that reflect the shapes created by the user and appearing as actual ingredients on a baked pizza.

Subsequently, the compositing module 220 generates a second image including the portion of interest included in each output image based on the region information. That is, the compositing module 220 composites a region excluding the portion of interest in each input image and a region of the portion of interest in the output image based on the region information. This step is the same as Step S618 in the first embodiment. Specifically, as illustrated in FIG. 12A, an image is generated by compositing the image of each ingredient after being subjected to the image style conversion processing with a background before being subjected to the image style conversion processing.

Subsequently, the compositing module 220 generates a second image. Specifically, as illustrated in FIG. 12B, a second image is generated by compositing the image before being subjected to the cutout by the cutout module 218 (image on the left side of FIG. 11B) and the images composited by the compositing module 220 (images on the right side of FIG. 12A) based on the region information.

With the above-mentioned steps, a second image exhibiting a portion of interest different in mode from that of the first image can be generated based on a SinGAN model and an input image. In the first embodiment and the second embodiment, the portion of interest corresponds to the defective portion shown partially on the target object, and a machine learning method of training, based on the second image (in this case, the second training image), a machine learning model that receives input of an image obtained by photographing a product and outputs a determination result indicating whether the product is a non-defective product or a defective product including the defective portion is described. However, as in the third embodiment, the generated second image may be used not only for learning purposes but also for other purposes (for example, an image to be displayed on a menu table). The third embodiment is particularly useful in a case of creating a large number of images that have similar portions of interest but are rich in variation in shape, number, arrangement position, and the like of the portions of interest.

The case in which the image of interest is created through use of the GUI described in the second embodiment has been described above, but in the third embodiment, the image of interest may also be created by the same method as in the first embodiment. For example, the image of interest may be generated through use of the random generation in the third embodiment as well. In this case, a plurality of SinGAN models 222 are created through use of at least two different images with ingredients of the same type placed thereon.

Specifically, for example, the first SinGAN model 222A is created by being trained by setting images of pizzas with only pieces of bell pepper placed thereon as first images. Meanwhile, the second SinGAN model 222B is created by being trained by setting, as first images, images of pizzas on which only pieces of bell pepper different in color and shape from those shown in the first images for the first SinGAN model 222A are placed thereon. Then, the image of interest may be generated by inputting a random noise to each of the first SinGAN model 222A and the second SinGAN model 222B.

Further, when the random generation is used in the third embodiment, the input image is input to a SinGAN model 222 different from the SinGAN model 222 used for generating the input image during the image style conversion processing in the same manner as in the first embodiment. That is, the input image generated based on the image of interest generated by the first SinGAN model 222A is input to the second SinGAN model 222B. Meanwhile, the input image generated based on the image of interest generated by the second SinGAN model 222B is input to the first SinGAN model 222A. Thus, it is possible to generate a second image representing at least two second images in which pieces of bell pepper having different colors and shapes are shown.

In addition, in the third embodiment, in the same manner as in the first embodiment, the extraction of the portion-of-interest image (corresponding to Step S610) and the generation and compositing of cut-out images (Step S614 to Step S620) may be performed or omitted as appropriate.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image generating method, comprising:
creating a SinGAN model including a generator and a discriminator in each of a plurality of layers based on a first image having a portion of interest shown partially on a target object;
generating an input image by compositing a target object image and a portion-of-interest image; and
generating, based on the SinGAN model and the input image, a second image exhibiting a portion of interest different in mode from the portion of interest of the first image.

2. The image generating method according to claim 1, wherein the generating of the second image includes inputting the input image to the generator in an intermediate layer among the plurality of layers.

3. The image generating method according to claim 2, wherein the generating of the input image includes generating the input image by cutting out a region of the portion of interest and a periphery of the portion of interest from the composited target object image and portion-of-interest image.

4. The image generating method according to claim 2, wherein the generator in the intermediate layer is determined based on a layout of the portion of interest shown in the input image.

5. The image generating method according to claim 1,
wherein the generating of the input image includes acquiring region information on the portion of interest, and
wherein the generating of the second image includes:
inputting the input image to the SinGAN model to generate an output image exhibiting the portion of interest different in mode from the portion of interest of the first image; and
generating, based on the region information, the second image including the portion of interest included in the output image.

6. The image generating method according to claim 1, the generating of the second image includes outputting an output image from the SinGAN model,
wherein the outputting of the output image includes:
inputting a random noise to the generator in at least a lowest layer; and
outputting the output image including the portion-of-interest image from the generator in a highest layer.

7. The image generating method according to claim 1, wherein the generating of the second image includes:
inputting a random noise to the generator in at least a lowest layer; and
outputting the second image from the generator in a highest layer.

8. The image generating method according to claim 1, wherein the portion of interest comprises a defective portion shown partially on the target object.

9. An image generating device, comprising:
at least one processor; and
at least one memory device configured to store a plurality of instructions to be executed by the at least one processor,
wherein the at least one memory device is configured to store a SinGAN model, which is created based on a first image having a portion of interest shown partially on a target object, and includes a generator and a discriminator in each of a plurality of layers, and
wherein the plurality of instructions cause the at least one processor to:
generate an input image by compositing a target object image and a portion-of-interest image; and
generate, based on the SinGAN model and the input image, a second image exhibiting a portion of interest different in mode from the portion of interest of the first image.

10. The image generating device according to claim 9, wherein the input image is input to the generator in an intermediate layer among the plurality of layers to generate the second image.

11. The image generating device according to claim 10, wherein the input image is generated by cutting out a region of the portion of interest and a periphery of the portion of interest from the composited target object image and portion-of-interest image.

12. The image generating device according to claim 10, wherein the generator in the intermediate layer is determined based on a layout of the portion of interest shown in the input image.

13. The image generating device according to claim 9,
wherein the plurality of instructions cause the at least one processor to:
acquire region information on the portion of interest when the input image is generated;
input the input image to the SinGAN model to generate an output image exhibiting the portion of interest different in mode from the portion of interest of the first image; and
generate, based on the region information, the second image including the portion of interest included in the output image.

14. The image generating device according to claim 9,
wherein the SinGAN model output an output image when the second image is generated,
wherein the plurality of instructions cause the at least one processor to:
input a random noise to the generator in at least a lowest layer; and
output the output image including the portion-of-interest image from the generator in a highest layer.

15. The image generating device according to claim 9, wherein the generating of the second image includes:
wherein the plurality of instructions cause the at least one processor to:
input a random noise to the generator in at least a lowest layer; and
output the second image from the generator in a highest layer.

16. The image generating device according to claim 9, wherein the portion of interest comprises a defective portion shown partially on the target object.

17. A non-transitory computer-readable information storage medium having stored thereon a program executed by a computer, the program causing the computer to operate as an image generating device configured to:
create a SinGAN model including a generator and a discriminator in each of a plurality of layers based on a first image having a portion of interest shown partially on a target object;
generate an input image by compositing a target object image and a portion-of-interest image; and
generate, based on the SinGAN model and the input image, a second image exhibiting a portion of interest different in mode from the portion of interest of the first image.
